(19) United States
(12) Patent Application Publication
(10) Pub. No.: US 2026/0247242 A1
(43) Pub. Date: Aug. 20, 2026

(54) WIRELESS COMMUNICATION SYSTEM, HANDOVER CONTROL DEVICE, WIRELESS COMMUNICATION METHOD, AND HANDOVER CONTROL PROGRAM

(71) Applicants: NTT, Inc., Tokyo (JP); NTT DOCOMO, INC., Tokyo (JP)

(72) Inventors: Munehiro MATSUI, Musashino-shi, Tokyo (JP); Junichi ABE, Musashino-shi, Tokyo (JP); Hisayoshi KANO, Musashino-shi, Tokyo (JP); Fumihiro YAMASHITA, Musashino-shi, Tokyo (JP); Takeshi ONIZAWA, Musashino-shi, Tokyo (JP); Atsushi MINOKUCHI, Tokyo (JP); Yuki HOKAZONO, Tokyo (JP); Kenta YAMAUCHI, Tokyo (JP); Yoshihisa KISHIYAMA, Tokyo (JP); Hinata KOHARA, Tokyo (JP); Yuto MUROKI, Tokyo (JP)

(73) Assignees: NTT, Inc., Tokyo (JP); NTT DOCOMO, INC., Tokyo (JP)

(21) Appl. No.: 19/156,411

(22) PCT Filed: Feb. 15, 2023
(86) PCT No.: PCT/JP2023/005255

§ 371 Date: Aug. 14, 2025

(51) Int. Cl. H04W 36/08; H04L 43/0852

(52) U.S. Cl. CPC H04W 36/083; H04L 43/0852

(57) ABSTRACT

The present disclosure provides a wireless communication system. The system includes a plurality of wireless communication stations connected to a data network. Wireless terminals located within a service area provided by the wireless communication station connects with the wireless communication stations to send and receive packets to and from the data network. Along with changes in the relative position between the wireless terminal and the wireless communication station, a handover procedure is executed to switch the connection of the wireless terminal from the current wireless communication station to a target wireless communication station. The priority of the handover procedure is determined for each wireless terminal. The handover procedure for the plurality of wireless terminals for which a trigger of the handover procedure has been occurred is carried out according to the priority.

### TECHNICAL FIELD

The present disclosure relates to a wireless communication system, a handover control device, a wireless communication method, and a handover control program using a non-terrestrial network.

### BACKGROUND ART

In recent years, mobile communication systems have evolved, allowing mobile services to be enjoyed in most terrestrial areas. One of the requirements for the future commercialization of the fifth generation (5G) or sixth generation (6G) mobile communication systems is ultra-coverage. The ultra-coverage means expanding the service area to locations where the installation cost of existing base stations would be expensive, or places where the setup of base stations is difficult, such as mountainous areas, maritime areas, or in the air. Additionally, there is a need for strengthening national resilience against natural disasters, and the emergence of communication systems that are resistant to ground disasters is highly desired.

To achieve the above, non-terrestrial networks (Non-Terrestrial Network: NTN) utilizing satellites, unmanned aerial vehicles (UAVs), high-altitude pseudo-satellites (HAPS), drones, and the like, are currently in the spotlight. FIG. 1 shows an example of an NTN using satellites. The satellite has base station functionalities and forms a mobile service area by emitting beams to the ground. Terminals on the ground within the mobile service area connect to the satellite, which in turn connects to the mobile network. The satellite has relaying functionalities, and packets transmitted from terminals are sent, through the satellite, ground base stations, and the mobile network, to the data network. Packets addressed to terminals from the data network are relayed in the same manner. Additionally, as a further development, a network with multiple satellites linked together can be considered. An example is shown in FIG. 2. Satellites connect links with each other and form a network. Satellites and aerial vehicles have routing capabilities, and the traffic sent from terminals is forwarded to the internet network.

As for communication services using satellites, there is Starlink, which provides communication services to the ground using low-earth orbit satellites. In Starlink, thousands to tens of thousands of low-earth orbit satellites launched form a service area on the ground, providing internet connection to communication devices within the service area. The orbit of the low-earth orbit satellites does not coincide with the rotation of the Earth, hence it appears to be constantly moving relative to a fixed point on the ground. The duration for which the fixed point on the ground can observe them is about 10 minutes, and thus it is not possible to keep a connection to the same low-earth orbit satellite continuously. A single low-earth orbit satellite cannot constantly cover the same area on the ground, but by arranging multiple low-earth orbit satellites in orbit to sequentially swap roles to cover the same ground area, constant communication services can be provided.

When providing mobile communication services on the ground, multiple base stations are arranged to construct a cellular network, comprehensively expanding the service area. When a terminal moves from the coverage area (cell) of the connected base station to the coverage area of another base station, handover process is used to change the connected base station, thereby providing seamless communication services.

The handover control is also necessary for NTN. In addition to cases where a terminal moves and transitions to the cell of a different base station, handovers due to system requirement might occur where the base station connected to the terminal is switched due to the movement of the aforementioned low-earth orbit satellite. An example of a handover occurrence due to the movement of a low-earth orbit satellite is shown in FIG. 3. The terminal is communicating within the service area of Low-Earth Orbit satellite 1, but due to the movement of the satellite, it will be out from the coverage area of Service Area 1. However, as it will eventually be in Service Area 2 of the Low-Earth Orbit satellite 2 for replacement, it becomes possible to connect with the low-earth orbital satellite 2. During the period when Service Area 1 and Service Area 2 overlap, the connection is changed to low-earth orbital satellite 2 through handover processing [Non-Patent Document 1].

### CITATION LIST

### Non Patent Literature

### Non Patent Literature 1

E. Juan, M. Lauridsen, J. Wigard, and P. Mogensen, “5G new radio mobility performance in LEO-based non-terrestrial networks”, IEEE Globecom Workshops, 2020

### SUMMARY OF INVENTION

### Technical Problem

As described above, when a handover owing to the movement of low-orbit satellites occurs for system-side reasons, all terminals within the service area will perform the handover [Non-Patent Literature 1]. In other words, during the handover of low-earth orbit satellites, all terminals in Service Area 1 need to be handed over to Service Area 2. However, the relative movement speed of low-earth orbit satellites to the ground is fast, and the period during which Service Area 1 and Service Area 2 overlap is short. Therefore, if all terminals within the overlap area perform the handover process, a large number of handover sequences will occur in a short period.

FIG. 4 shows a handover sequence in 5G. When the conditions are met, the terminal (UE) sends a measurement report to the connected base station (Source gNB). After this, the handover is decided at the connected base station, and after the migration process is performed between the connected base station and the destination base station (Target gNB), the terminal switches the connection to the destination base station.

In the case of carrying out handover processing sequentially on all terminals in a short period, depending on the number of terminals, there arises a situation where the process cannot be finished in time, and the sequence cannot be completed. As a result, there is a possibility that many terminals will be disconnected because the handover could not be performed. Additionally, the traffic between the terminal and the connected base station or between the connected base station and the destination base station increases rapidly due to the instant increase in handover sequences. Depending on the bandwidth of the wireless line, there is a possibility of traffic congestion occurring, which can interrupt the exchange of sequence information. Furthermore, since the processing load within the base station can instantly increase, depending on the system's processing capacity, it may be unable to handle the large volume of handover processes within the system, resulting in congestion of these processes, potentially leading to terminals that cannot complete handovers. In particular, in use cases such as Ultra-reliable and Low Latency Communications (URLLC), which require high reliability in mobile communications, handover failures are not acceptable since a disconnection causes a significant impact on the service.

As described above, in a handover triggered by the system-side circumstances in an NTN (Non-Terrestrial Network), handover failures could occur frequently if a large number of terminals perfume handovers simultaneously. Meanwhile, various types of applications such as voice calls, video transmission, and IoT communication using sensors are being used on terminals. Each application has different requirements for QoS (Quality of Service), such as the required transmission speed and acceptable response time. For example, URLLC for autonomous driving support requires low latency, and communication interruptions are not tolerated. On the other hand, in IoT services exemplified by sensing, it is possible, depending on the service, to allow for a certain level of latency.

Thus, the first object of the present disclosure is to provide a wireless communication system that performs prioritized execution of handovers according to the required QoS by setting the priority of handover processing execution based on the terminal's required QoS.

Further, the second object of the present disclosure is to provide a handover control device that performs prioritized execution of handovers according to the required QoS by setting the priority of handover processing execution based on the terminal's required QoS.

Furthermore, the third object of the present disclosure is to provide a wireless communication method for performing prioritized execution of handovers according to the required QoS by setting the priority of handover processing execution based on the terminal's required QoS.

Furthermore, the fourth object of the present disclosure is to provide a handover control program for causing a handover control device to perform prioritized execution of handovers according to the required QoS by setting the priority of handover processing execution based on the terminal's required QoS.

### Means to Solve Problems

A first aspect of the present disclosure is, in order to achieve the above-mentioned object, a wireless communication system including a plurality of wireless communication stations connected to a data network, in which wireless terminals located within a service area provided by the wireless communication stations are connected to the wireless communication stations to send and receive packets with the data network, wherein
said wireless communication system is preferably configured to perform:
a handover procedure for switching a connection destination of the wireless terminal from the currently connected wireless communication station to a target wireless communication station as the relative position between the wireless terminal and the wireless communication stations changes;
a priority determination procedure for deciding a priority of the handover procedure for each wireless terminal; and
a priority reflection procedure for proceeding with the handover procedure of a plurality of wireless terminals for which a trigger of the handover procedure has been occurred, according to said priority.

Further, a second aspect of the present disclosure is a handover control device for controlling a handover procedure for switching a connection destination of a wireless terminal from a currently connected wireless communication station to a target wireless communication station, in response to the relative positional change of a plurality of wireless communication stations connected to a data network and the wireless terminal connected to said wireless communication stations to send and receive packets with the data network,
said handover control device is preferably configured to perform:
a procedure for receiving information relating to required QoS of service provided by the wireless terminal from said wireless terminal;
a procedure for determining priority of the handover procedure for each wireless terminal based on the information related to the required QoS; and
a procedure for notifying said priority for each wireless terminal to the wireless communications stations in order to cause them to proceed with the handover procedure for the plurality of wireless terminals for which a trigger of the handover procedure has been occurred, according to said priority.

Furthermore, a third aspect of the present disclosure is a wireless communication method for transmitting and receiving packets, via a plurality of wireless communication stations connected to a data network, between a wireless terminal located within a service area provided by the wireless communication station and the data network, preferably including:
switching a connection destination of the wireless terminal from the currently connected wireless communication station to a target wireless communication station as the relative position between the wireless terminal and the wireless communication stations changes;
deciding a priority of the handover procedure for each wireless terminal; and
proceeding with the handover procedure of a plurality of wireless terminals for which a trigger of the handover procedure has been occurred, according to said priority.

Moreover, a fourth aspect of the present disclosure is a handover control program for controlling a handover procedure for switching a connection destination of a wireless terminal from a currently connected wireless communication station to a target wireless communication station, in response to the relative positional change of a plurality of wireless communication stations connected to a data network and the wireless terminal connected to said wireless communication stations to send and receive packets with the data network, including a computer readable program for causing a handover control device provided with computer resources to execute:
a procedure for receiving information relating to required QoS of service provided by the wireless terminal from said wireless terminal;
a procedure for determining priority of the handover procedure for each wireless terminal based on the information related to the required QoS; and
a procedure for notifying said priority for each wireless terminal to the wireless communications stations in order to cause them to proceed with the handover procedure for the plurality of wireless terminals for which a trigger of the handover procedure has been occurred, according to said priority.

### Advantageous Effects of Invention

According to the first to fourth aspects, handover processing can proceed based on the priority set for each device on the basis of the required QoS under an environment with numerous devices. Therefore, according to these aspects, it is possible to properly complete the handover of numerous devices in an environment where various services are mixed together, without causing a decline in QoS. Additionally, since the number of devices subject to the handover are restricted, the sequence and traffic volume involved in the handover can be reduced, thereby improving the overall success rate of handovers.

### BRIEF DESCRIPTION OF DRAWINGS

FIG. 1 is a diagram showing an example of a non-terrestrial network (Non-Terrestrial Network: NTN) using satellites;

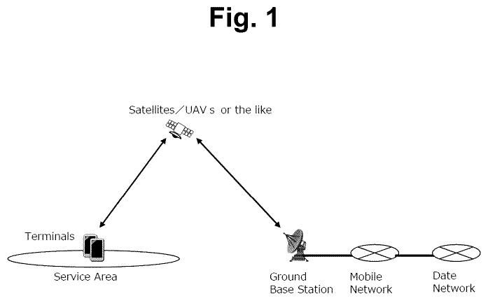

FIG. 2 is a diagram showing an example of a network in which multiple satellites are linked;

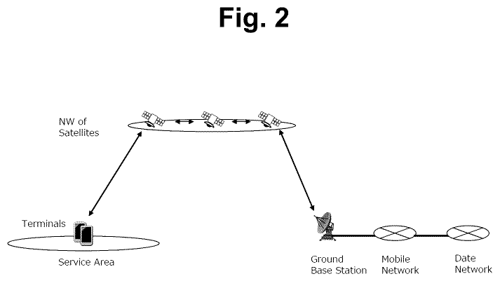

FIG. 3 is a diagram illustrating an example of handover occurrence due to the movement of low-earth orbit satellites;

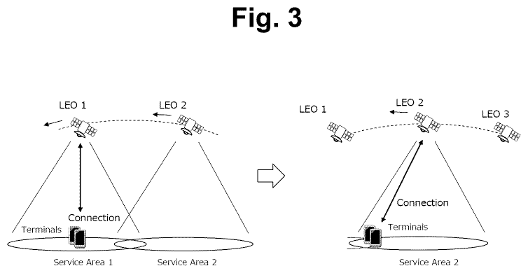

FIG. 4 is a diagram illustrating the handover sequence in 5G;

FIG. 5 illustrates a configuration of the wireless communication system of a first embodiment of the present disclosure;

FIG. 6 is a flowchart for explaining a flow of processing at the time of a UE connection in the wireless communication system of the first embodiment of the present disclosure;

FIG. 7 is a flowchart for explaining a process flow at the time where a handover trigger occurs in the wireless communication system of the first embodiment of the present disclosure;

FIG. 8 is a diagram illustrating an assumed network for explaining an operation example of the wireless communication system of the first embodiment of the present disclosure;

FIG. 9 is a diagram showing a state where three UEs 10 are located in a region where the service area of the LEO satellite 1 overlaps with the service area of the LEO satellite 2;

FIG. 10 is a diagram for explaining the features of the wireless communication system of a second embodiment of the present disclosure;

FIG. 11 is a flowchart for explaining a process by which the wireless communication system of the second embodiment of the present disclosure selects a UE for handover processing;

FIG. 12 is a diagram showing the sequence of Conditional Handover adopted by the wireless communication system of a third embodiment of the present disclosure;

FIG. 13 is a flowchart explaining a process flow at the time where a handover trigger occurs in the wireless communication system of the third embodiment of the present disclosure;

FIG. 14 is a diagram illustrating a configuration of the wireless communication system according to a fourth embodiment of the present disclosure;

FIG. 15 is a flowchart for explaining a flow of handover control in the wireless communication system according to the fourth embodiment of the present disclosure;

FIG. 16 is a diagram for explaining an operation of the wireless communication system according to the fourth embodiment of the present disclosure;

FIG. 17 is a flowchart for explaining a flow of processing at the time of a UE connection in the wireless communication system of a fifth embodiment of the present disclosure; and

FIG. 18 is a diagram illustrating an operation of the wireless communication system of a sixth embodiment of the present disclosure.

### DESCRIPTION OF EMBODIMENTS

### First Embodiment

### Configuration of First Embodiment

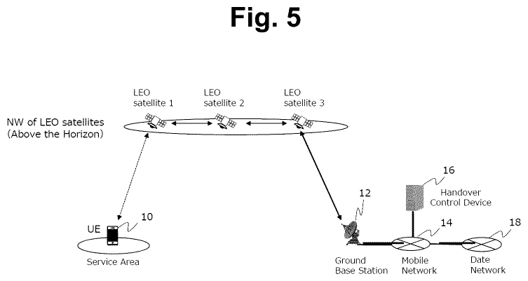

FIG. 5 shows the wireless communication system in the first embodiment of the present disclosure. The wireless communication system in the present embodiment includes Low-Earth Orbit (LEO) satellites 1 to 3, a terminal (User Equipment: UE) 10, ground base station 12, mobile core network 14, and handover control device 16. The LEO satellites 1 to 3 have a mobile base station functionality and form a service area for the ground. Furthermore, link functionalities and routing functionalities for relaying signals are implemented, allowing for connection links to be established between LEO satellites 1 to 3 to build an LEO satellite network, and relaying signals sent and received between the UE 10 in the coverage area and the mobile core network 14.

The LEO satellites 1 to 3 orbit the Earth and appear to be moving relative to a fixed point on the ground. LEO satellites 1 to 3 appear above the horizon and eventually sink below it, but since multiple LEO satellites are positioned on the same orbit, a new LEO satellite appears above the horizon in succession. In the present embodiment, it is assumed that there are always three LEO satellites, 1 to 3, above the horizon. The LEO satellites are connected with links to each other, the UE 10 within the service area of the LEO satellite 1 can connect to the mobile core network 14 via the LEO satellites 2 and 3.

the UE 10 is communicable with a mobile communication system, the UE 10 within the service area connects to the data network 18 through LEO satellites 1 to 3 equipped with base station functionalities and the mobile core network 14 so as to execute various communication applications. The ground base station 12 transmits and receives signals between the LEO satellite and the terrestrial mobile core network 14.

The mobile core network 14 performs mobility control such as management of the connected UE 10 and handover, as well as send-receive session control. Additionally, it transfers packets between the UE 10 and the data network 18. Furthermore, as a part of it, the mobile core network 14 is equipped with a handover control device 16.

The handover control device 16, as a part of the mobile core network 14, collects QoS information from the UE 10 and sets the priority for handover for each UE 10 according to the collected QoS. The set priority is notified to the mobile base station functionalities within the LEO satellites 1 to 3. The handover control device 16 is equipped with computer resources such as a CPU, memory device, and various interfaces. The memory device stores a handover control program that is executed by the CPU. The above functionalities of the handover control device 16 are realized by the CPU executing its handover control program.

When the mobile base station functionality within LEO satellites 1-3 receives a measurement report from a UE 10 upon the trigger for the UE 10 handover, it performs the handover process for the UE 10 based on the priority of the handover.

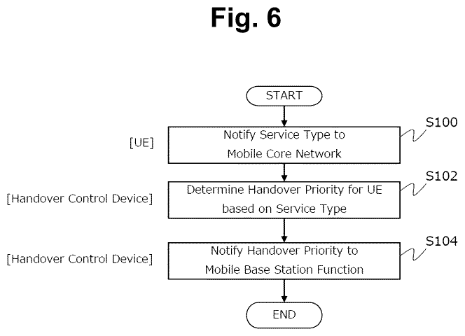

FIG. 6 shows a processing flow when the UE is connected in the system of the present embodiment. When connecting to the network for the first time, the UE 10 notifies the mobile core network 14 of the service type as QoS (step 100). Based on the service type information, the handover control device 16 in the mobile core network 14 sets the handover priority for the UE 10 (step 102). Furthermore, the priority of the handover is notified to the mobile base station functionality within LEO satellites 1 to 3 (Step 104).

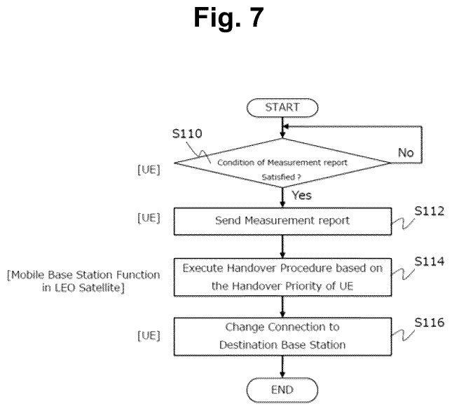

Next, FIG. 7 shows the process flow upon the occurrence of a handover trigger in the system of the present embodiment. When a handover trigger occurs and a condition of the measurement report is met (Step 110), the UE 10 sends a measurement report to the mobile base station functionality within a LEO satellite (Step 112). The mobile base station functionality controls the handover of the UE 10 based on the handover priority set for each UE 10 in advance (Step 114). Then, the UE 10 connects to the destination base station and completes the handover (step 116).

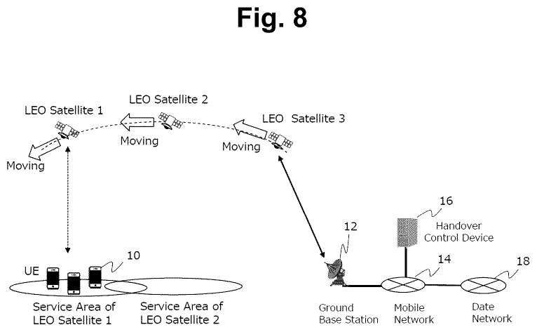

The following illustrates an example of operation. A network as shown in FIG. 8 is assumed. LEO satellite 1, LEO satellite 2, and LEO satellite 3 are connected by links to form a LEO satellite network. It is assumed that a service type and the required QoS corresponding to that service type are considered in the UE 10, as shown in Table 1.

TABLE 1

| | | Required QoS | |
|---|---|---|---|
| Service | | Transmission | Allowable |
| Type | Content of Service Type | Speed | Delay Time |
| 1 | High-Speed Large-Capacity | 100 Mbit/s | 200 ms |
| | Service | | |
| 2 | Ultra-Reliable Low-Latency | 30 Mbit/s | 50 ms |
| | Service | | |
| 3 | IoT services | 1 Mbit/s | 10 s |

It is assumed that there are three UE 10 within the service area of the LEO satellite 1. The identifiers for the three UA 10 units are A, B, and C. Furthermore, they are assumed to provide service type 1, service type 2 and service type 3, respectively. The condition for sending a measurement report at a UE 10 is that where the received power from the connected base station (LEO satellite) falls below a predefined threshold, and the received power from another base station (LEO satellite) exceeds a predefined threshold. The UE 10 unit regularly receives signals from connected base stations and adjacent stations and observes the reception power.

When the UE 10 starts communication, it connects to the mobile core network 14 through the LEO satellite 1. At this time, it informs the handover control device 16 within the mobile core network 14 of the service type. The handover control device 16 sets the handover priority for each UE 10 in accordance with the service type. In this case, priority is set from the service type with the shortest acceptable delay time. In the example shown in Table 1, priority 1 is assigned to service type 2, priority 2 to service type 1, and priority 3 to service type 3. This information is notified to the mobile base station functionality within the LEO satellite and recorded together with identifiers A, B, or C for the UE 10. Table 2 shows information from this time.

TABLE 2

| UE ID | Service Type | Handover Priority |
|---|---|---|
| A | 1 | 2 |
| B | 2 | 1 |
| C | 3 | 3 |

Subsequently, registration (attach) procedure for the UE 10 or the likes are carried out and a session is established between the UE 10 and the mobile core network 14. Once these procedures are completed, the UE 10 connects to the data network 18 and starts communication.

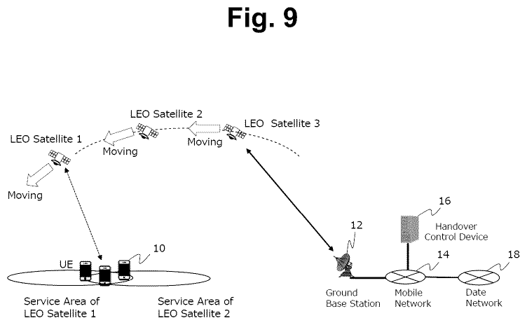

Next, assume that the movement of LEO satellites 1 to 3 has resulted in the state shown in FIG. 9. In other words, envision a scenario where the three UEs 10 are located within the area where the service area of LEO satellite 1 overlaps with that of LEO satellite 2. As the LEO satellites 1 to 3 move, the distance between the LEO satellites 1 to 3 and the UE 10 will vary, respectively. As a result, there will arise a state where the received power from LEO satellite 1, to which the UE 10 is connected, falls below a certain threshold, while the received power from LEO satellite 2 exceeds a certain threshold. This change serves as a trigger for the handover from Service Area 1 to Service Area 2, and the three UEs 10 send a measurement report to the mobile base station functionality within the LEO satellite. This measurement report includes the received power information of the signals received from each base station. When the mobile base station functionality receives the measurement report from the UE 10, it performs the handover in order, starting from the UE 10 with the highest priority based on the handover priority.

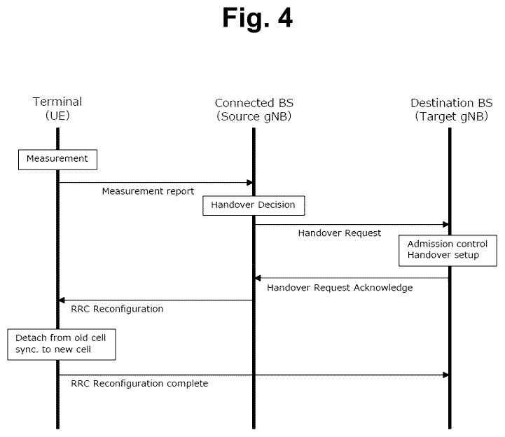

In the above example, a handover process is carried out from the UE 10, identified as B, followed by handovers in the order of A and C. The handover process proceeds according to the sequence depicted in FIG. 4. Specifically, the UE connection transfer process to the destination base station is carried out, and a handover is instructed to the UE 10. Subsequently, the UE 10 connects to the destination LEO satellite 2 and completes the handover process.

As described above, in the present embodiment, the priority of the handover process is set based on the required QoS of the UE 10, and the handover process is executed according to that priority. As a result, it is possible to increase the success rate of handovers for the UEs that have QoS where disconnection of communication is not allowed, like URLLC, and to prevent communication disconnection due to handover failure. On the other hand, in IoT services, because the permissible delay is substantial, even if a handover fails and results in a communication disconnection, the impact on the service is relatively minor. Therefore, by lowering the priority of handovers for IoT services and the like, the impact on the service can be minimized, while increasing the handover success rate for other services, such as URLLC, can enhance the overall quality of service across the system. Additionally, the system can limit the UE subject to handover simultaneously, which can help alleviate congestion in handover processing and overall increase the success rate of handovers.

Also, if there are multiple terminals of the same service type, the priority of handover remains the same. In this case, it is possible to set the handover order randomly among terminals of the same service type, or to set the handover order according to the order in which QoS information was notified to the mobile core network 14 at the time of terminal connection. Additionally, it is possible to set the handover order by combining other information that the terminal possesses, such as the access identity (access class control information) of the UE, which will be described later in the fifth embodiment.

In the first embodiment described above, an example (Regenerative type) was explained where a mobile base station functionality is mounted on the satellite, however, the present disclosure is not limited to this example. Even in a Transparent type where the satellite is equipped only with functionalities such as reception power amplification and frequency conversion, similar processing is possible.

In the aforementioned the first embodiment, as a condition for sending the measurement report, two conditions were used: the received power from the connected base station (LEO satellite) falls below a certain threshold, and the received power from another base station (LEO satellite) exceeds another threshold. However, the present disclosure is not limited to this, and for example, it is permissible to use only one of these conditions. Furthermore, although the received power from the LEO satellite reaching the UE 10 was used, the present disclosure is not limited to this. For example, it is conceivable to calculate the time a handover will occur at the UE 10 using the orbital information of the LEO satellite, the location information of the UE 10, and the time, with the arrival of this time as a condition for sending a measurement report.

Furthermore, in the first embodiment described above, the case where three types of services coexist is assumed, but the present disclosure is not limited to that. For example, it may be assumed that the aforementioned service type combinations are used, such as IoT services that require ultra-reliable low latency. In this case, it is possible to perform processing similar to the first embodiment by appropriately setting priorities according to factors such as the permissible delay time.

Further, in the first embodiment described above, transmission speed and permissible delay time were assumed as the required QoS, but the present disclosure should not be limited to these. For example, metrics such as delay jitter may be used as required QoS. Additionally, in sensing services, which are part of LOT services, there may be cases where the data sent from the UE is small. In such cases, connection time per unit time may be assumed as the required QoS.

Additionally, in the first embodiment described above, a mobile communication system using LEO satellites was assumed, but the present disclosure is not limited to that. The method disclosed herein can also be applied to mobile communication systems using geostationary satellites, medium-altitude satellites, high altitude platform stations (HAPS), and drones.

### Second Embodiment.

In the above-mentioned the first embodiment, the UEs subject to handover processing are selected according to the priority set for each UE based on the required Quality of Service (QoS). Then, based on the priority, the order of handover was set and handover processing was carried out. According to this method, there might be cases where the limit of handover processing is reached only by the UEs with priority 1, while in some instances, handover for all UEs might be feasible without regard to priority, depending on the number of the UEs per each priority connected to the base station.

In the present embodiment, the handover control device 16 pre-selects UEs subject to handover while prioritizing from high priority UEs according to the number of the UEs (a) for which a trigger of handover process will occur within a certain period of time and the maximum number of the UEs (B) that can perform handover without any issues within the certain period of time.

The UE has the capability to determine its own location using GNSS such as GPS, and it regularly reports its own location to the mobile base station functionality within the LEO satellite. The mobile base station functionality transmits the UE's location information to the handover control device 16 within the mobile core network 14. The calculation of “x” is executed based on information of a satellite's position and a UE's location at the time of after the certain period of time.

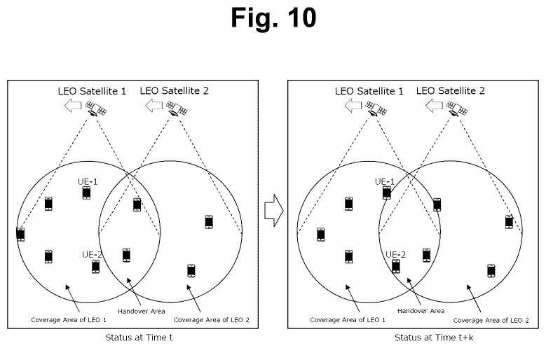

The image of this stage is shown in FIG. 10. The location of the UE and the coverage areas of each satellite can be recognized as shown on the left in FIG. 10 at time t based on the location information notified from the UE, the orbit information of the satellites, and the shape and size (such as area radius) of each satellite's service area. The area where the coverage areas of LEO satellite 1 and LEO satellite 2 overlap becomes the handover area, and a handover process trigger is occurring for UEs present within this area.

The right side of FIG. 10 shows an estimated diagram of the locations of the UEs and the coverage areas of each satellite at time t+k. The situation shown on the right side of FIG. 10 can be inferred from the orbital information of the satellites. Since UE-1 and UE-2, which have existed within the coverage area of LEO satellite 1 at time t, will be within the handover area at time t+k, it is calculated that the number of UEs for which a new handover process is triggered is x=2. It should be noted that the information of β is pre-set according to the processing capacity of the system for conducting a handover.

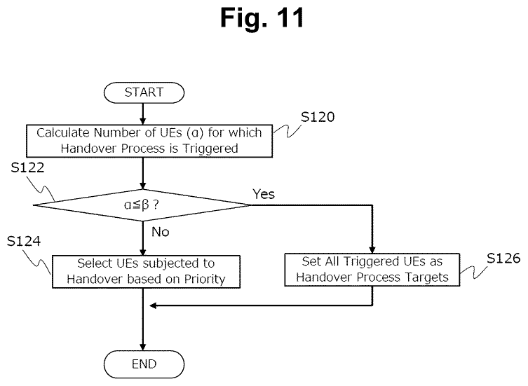

FIG. 11 shows the selection flow of UEs for handover processing. The handover control device 16 calculates a at regular intervals from the location information periodically reported by the UE and the trajectory information of satellites (Step 120).

At certain intervals, compare a and B (step 122), and if α is not less than or equal to β, designate the UE with higher priority as the target for the handover process (step 124). On the other hand, if α is less than or equal to β, designate all UEs where a handover opportunity has arisen as targets for the handover process (step 126). Table 3 shows an example of the number of terminals per service type existing in the handover area.

TABLE 3

| Service Type | Content of Service Type | Number of UEs |
|---|---|---|
| 1 | High-Speed Large-Capacity Service | 100 |
| 2 | Ultra-Reliable Low-Latency Service | 50 |
| 3 | IoT services | 1000 |

In the example shown in Table 3, as x, there are 100 UEs of service type 1, 50 UEs of service type 2, and 1000 UEs of service type 3 within the handover area. If the maximum number β of handovers that can be performed within a certain time period is set to 50, all UEs of the highest priority service type 2 will be selected as the target of handover. If the maximum number β of handovers that can be performed simultaneously is 200 units, then in addition to the 50 units of type 2 service UEs, 100 units of type 1 service UEs will also be selected as the target for handovers.

In the second embodiment described above, selection of the UEs subject to handover are executed while separating them by their priority groups; however, the present disclosure is not limited to this approach. When there is room for the number of the UEs β that can be subjected to handover processing within a certain time, the UEs for handover may be selected until the upper limit is reached. In the example shown in Table 3, if the maximum number of simultaneous handovers is set to 200, then in addition to 100 UEs of service type 1 and 50 UEs of service type 2, 50 UEs of service type 3 can also be targets of handover. Therefore, from Service Type 3 UE, 50 units may be selected through methods such as on a first-come-first-served basis or random selection, and those can also be included as subjects of handover.

Moreover, in the above-mentioned the second embodiment, the movement of the UE is not taken into account for convenience, but the present disclosure is not limited to this. For example, it is also possible to collect information such as the direction of movement of the UE, and estimate the position of the UE after a certain period based on that information. This allows for the increase in the calculation accuracy of a.

### Third Embodiment

The aforementioned the first embodiment assumed a normal handover. In the present embodiment, a mechanism for conditional handover is used, where the handover is performed when the handover conditions are met on the UE side.

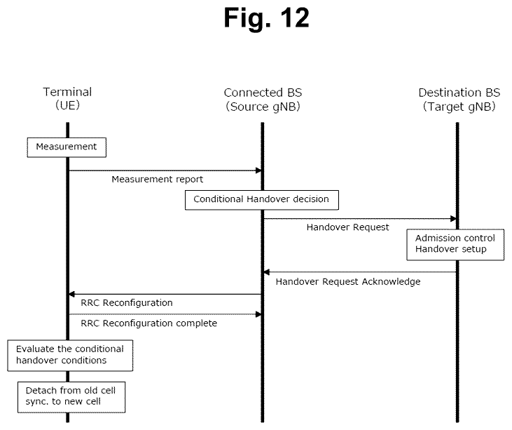

A sequence of conditional handover is shown in FIG. 12. When the condition is met on the UE side, the UE switches the connection to the destination base station so as to reduce the load of handover process. By performing the connection change process between the destination base station and the UE in advance, the load of sequence and processing can be reduced when handover triggers occur.

The configuration of the wireless communication system in the present embodiment is the same as shown in FIG. 5. Additionally, the flowchart during UE connection is the same as FIG. 6.

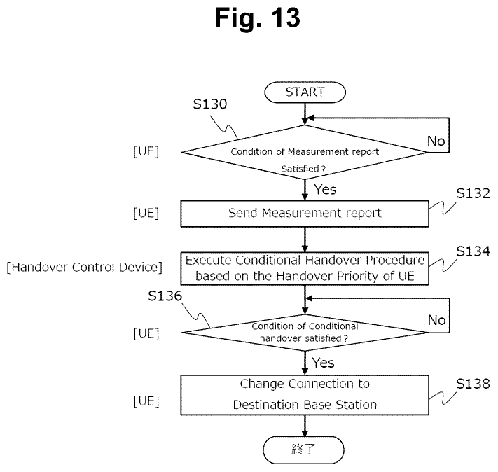

FIG. 13 shows a flowchart at the time of handover trigger occurs. When a condition for a measurement report is met (Step 130), the UE 10 sends the measurement report to the handover control device 16 in the mobile core network 14 (Step 132). The handover control device 16 performs conditional handover processing based on the pre-set handover priority of the UE 10 (Step 134). When a condition for conditional handover is satisfied (step 136), the UE 10 connects to the target base station and completes the handover (step 138).

Next, an example of operation is shown. Assume the same network as in FIG. 8. For the service type and required QoS of the UE 10, the case shown in Table 1 is assumed. The maximum number of the UEs that can perform the handover process without any issues within a certain period of time, B, is assumed to be two.

The condition by which the UE 10 sends a measurement report is arrival of specific time of just before the occurrence of a handover trigger (a specific time earlier), and whether it is satisfied is determined based on the orbital information of LEO Satellites 1-3, the location information of the UE 10, and the time. Additionally, the condition for a conditional handover is the same as in the first embodiment, where the received power from the connected base station (LEO Satellite 1) falls below a certain threshold and the received power from another base station (LEO Satellite 2) exceeds a certain threshold.

When the UE 10 starts communication, it connects to the mobile network through the LEO Satellite 1, as in the first embodiment, and notifies the handover control device 16 within the mobile core network 14 about the service type. The handover control device 16 sets the priority of the UE 10 concerning the handover according to the service type and notifies the mobile base station functionality within the LEO satellite of the result. The mobile base station functionality stores the notified information. The information at this time is similar to Table 2. After this, the registration (attach) process of the UE 10 and other procedures are performed, a session is established between the UE 10 and the mobile core network 14, and the UE 10 connects to the data network 18 to start communication.

Next, when the sending conditions for the measurement report are met at a UE 10, the UE 10 sends a measurement report to the handover control device 16. The handover control device 16 receives the measurement report and then selects two high-priority UEs to perform a conditional handover. That is to say, it carries out the conditional handover process for the UEs 10 identified by the UEs identifier A (priority 2) and B (priority 1). Specifically, it handles UE connection migration to the target base station (LEO satellite 2) and instructs a conditional handover for the UEs 10 identified by A and B.

Next, assuming that the state as shown in FIG. 9. is implemented due to the movement of the LEO satellites. It is an opportunity for a handover from Service Area 1 to Service Area 2, and the conditions for conditional handover are met in the UEs 10 with identifiers A and B. the UEs 10 connect to the next LEO satellite 2 and complete the handover process.

As mentioned above, in the system of the present embodiment, the priority of conditional handover processing is set based on the required QoS of the UE 10, and the conditional handover is executed. This makes it possible to achieve effects similar to those in the first embodiment.

### Fourth Embodiment

In the first to third embodiments described above, a method for responding to handover due to the movement of LEO satellites was explained. In the present embodiment, a method for switching feeder links (links between unmanned aerial vehicles and ground base stations) in a non-terrestrial network using an unmanned aerial vehicle with a transparent type signal relay functionality is described.

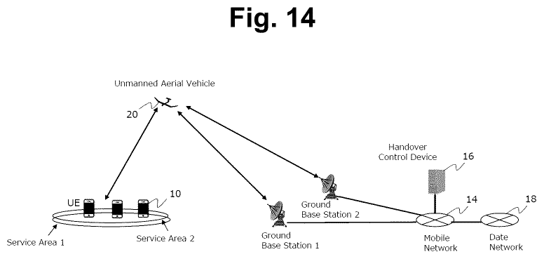

FIG. 14 shows the wireless communication system in the present embodiment. The wireless communication system of the present embodiment is composed of an unmanned aerial vehicle 20, UEs 10, ground base stations 1, 2, a mobile core network 14, and a handover control device 16. The unmanned aerial vehicle 20 can remain in approximately the same location by circling in the air and forming a service area by directing a beam toward the ground. Further, it relays signals of the service link (the link between the UEs 10 and the unmanned aerial vehicle 20) and of the feeder link by performing frequency conversion and amplification of transmission power on the received wireless signal without modulating or demodulating the signal. Furthermore, it has a functionality of changing the ground base stations 1 and 2 as a connection target by controlling the antenna's directivity for the feeder link.

The above-mentioned signal relay functionality and antenna are provided with two systems so as to allow two service areas to be formed in the same location. Ground base stations 1 and 2 are equipped with mobile base station functionalities, performing conversion processing between wired and 5G wireless signals, as well as handover control. Additionally, it forms Service Areas 1 and 2 via unmanned aerial vehicles 20, accommodating the UEs 10 within these service areas. The handover control device 16 manages the handover control when feeder link disconnections are expected to occur, by controlling the transmission power of ground base stations 1 and 2 based on weather prediction information.

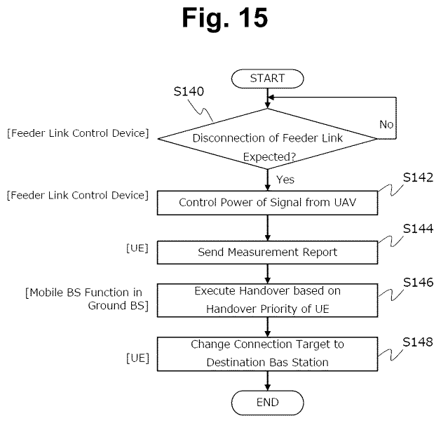

FIG. 15 shows a flow of handover control in the present system. In a case where a feeder link disconnection is expected due to rainfall (step 140), the transmission power of ground base stations 1 and 2 is controlled so as to cause the UEs 10 to send measurement reports (step 142). The UEs 10 send the measurement reports to the mobile base station functionality within the ground base stations 1 and 2 responding to the change in the received power (Step 144). The mobile base station functionality controls the handover of the UEs 10 based on the predefined handover priorities for the UEs 10 (Step 146). Subsequently, the UEs 10 connects to the target base station and completes the handover (Step 148).

Next, an operational example is shown. Consider a network similar to that shown in FIG. 14. The ground base stations 1 and 2 are installed in geographically separated locations so that the correlation of weather conditions is reduced. The ground base stations 1 and 2 form Service Areas 1 and 2 on the ground through the unmanned aerial vehicle 10. Assume that these service areas overlap. Also assume that there are three UEs 10 in Service Area 1, corresponding to service types 1, 2 and 3, respectively. Similarly, there are three UEs 10 within the Service Area 2, each corresponding to service types 1, 2 and 3.

Upon initial connection, UEs 10 communicates the service type to the handover control apparatus 16 within the mobile network, following the flowchart shown in FIG. 6. The handover control device 16 sets the priority for handover for each UE 10 according to the service type and notifies the mobile base station functionality within ground base stations 1 and 2 of the result. The mobile base station functionality stores the notified information. The UE 10 periodically receives signals from the connected base station and surrounding base stations via unmanned aerial vehicle 20 and observes the received power. The condition for sending a measurement report from the UE 10 is met when the received power from the connected base station (ground base station 1) falls below a certain threshold and the received power from another base station (ground base station 2) exceeds a certain threshold.

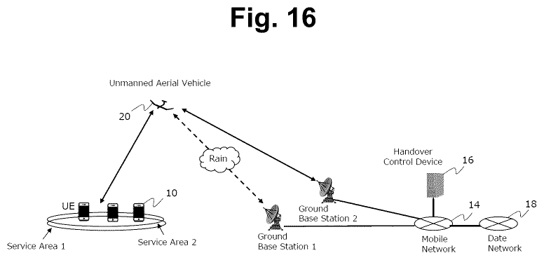

Next, assume that heavy rain is predicted in the area where ground base station 1 is located. At this time, as shown in FIG. 16, the wireless link between the unmanned aerial vehicle 20 and the ground base station 1 may be disconnected due to attenuation caused by rainfall. Therefore, when a heavy rain warning is issued in the vicinity of the ground base station 1, the handover control device 16 slightly lowers the transmission power of the ground base station 1 and slightly increases the transmission power of the ground base station 2 so that the conditions for sending a measurement report at the UE 10 are met. The three UEs 10, when the received power from the connected ground base station 1 falls below a certain threshold and the received power from the ground base station 2 exceeds a certain threshold, send a measurement report to the mobile base station functionality within ground base stations 1 and 2. The mobile base station functionality, upon receiving the measurement report from the UE 10, executes handover in a sequence based on handover priority. Specifically, the process of UE connection transition to the target base station is performed according to the sequence shown in FIG. 4. After this, the UE 10 moves to the target Service Area 2 to connect and completes the handover process.

As described above, the system of the present embodiment can satisfy the required QoS of the UE 10 by setting a priority based on its required QoS and performing a handover when a feeder link disconnection due to heavy rain or similar conditions is anticipated. Furthermore, as it is possible to narrow down the UE 10 targets for handovers, this approach can alleviate congestion during handover processing and increase the overall handover success rate.

Note that in the fourth embodiment described above, measurement reports are made to be sent to the UE 10 by controlling the transmission power of the ground base stations 1 and 2, but the present disclosure is not limited to that. For example, if the system includes a functionality to send a command directly to the UE 10 to instruct a handover, this functionality can be used to send measurement reports.

### Fifth Embodiment

In the first to fourth embodiments described above, when a UE first connects to the network, the service type is notified to the mobile core network 14 as the required QoS of the UE to control the handover. In the present embodiment, instead of the UE's service type, the information of the UE's access identity is used. Access identity information is information assigned to each UE in advance and is written into the SIM in the UE. Table 4 shows the list of access identities.

TABLE 4

| Access | |
|---|---|
| identity | UE Configuration |
| 0 | Regular UE |
| 1 | UE configured for multimedia priority services (MPS) |
| 2 | UE configured for mission critical service (MCS) |
| 3 | UE for which disaster condition applies |
| 4-10 | Reserved |
| 11 | UE configured for PLMN use |
| 12 | UE configured for security services |
| 13 | UE configured for public utilities |
| 14 | UE configured for emergency services |
| 15 | UE configured as PLMN staff |

In the 3GPP (registered trademark) standards, a class is defined for each UE, with general UE having 0, security service having 12, and emergency service having 14. Thus, in the system of the present embodiment, the UEs for emergency communication or for system maintenance, for which identity 12 or 14 is assigned is determined to have a high priority of QoS and is prioritized for handover.

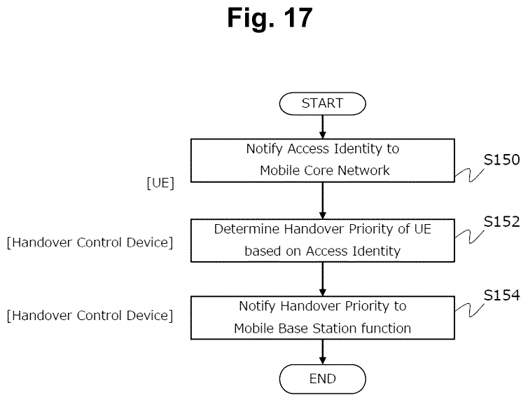

A flowchart for UE connection in the system of the present embodiment is shown in FIG. 17. The UE 10 notifies its access identity to the mobile core network 14 (Step 150). Based on the access identity obtained from the mobile core network 14, the handover control device 16 sets the handover priority for each UE 10 (Step 152). Then, the handover control device 16 notifies the mobile base station functionality of the set priority (Step 154). The system of the present embodiment is capable of performing the control described in the first to fifth embodiments in the same manner.

If there are several UEs with the same access identity value, the handover priority will be the same. In this case, as described in the first embodiment, the order of handover between terminals with the same access identity can be set randomly, based on QoS information on a first-come-first-served basis, or it can be set based on a combination with other information held by the terminal, such as service type.

### Sixth Embodiment

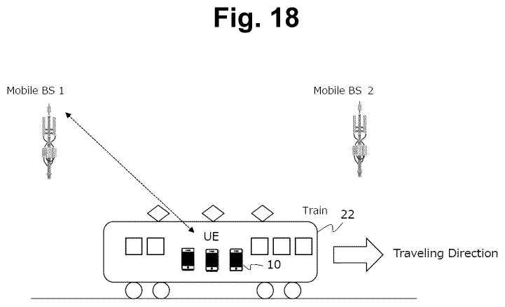

The first to fifth embodiments described above assume a mobile communication system via satellites; however, the method disclosed here can also be applied to terrestrial mobile communication systems. For example, as shown in FIG. 18, there may be a situation where it becomes necessary to hand over the UEs 10 held by passengers all at once to a new base station as the train 22 (which could also be a moving object like an aircraft) moves. The UEs 10 inside the train 22 are connected to mobile base station 1 and, due to handovers with the movement of the train, become connected to mobile base station 2 located in the direction of travel. According to handover control based on the priorities described in the first to fifth embodiments, even in such situations, it is possible to enhance handover success rates while suppressing processing congestion accompanying handovers.

It should be noted that, in addition to the first to fourth aspects described above, the present disclosure encompasses the fifth to fifteenth aspects described below.

In the fifth aspect, a communication system is described where a communication station forms a service area, terminals within the service area connect to the communication station, and the transmission and reception of packets between the terminals and a data network are conducted, wherein
the aspect provides a wireless communication system characterized in that:
being equipped with a functionality that periodically determines the priority of handover procedure for the terminals; and
executing the handover procedure of the terminals after selecting terminals for targets of the handover based on the priority and the number of the terminals subject to handover, or determining the order of handover procedure for the terminals based on the priority, at the timing of handover procedure by which the terminal changes the communication station to connect to.

The sixth aspect involves a wireless communication system according to the fifth aspect, characterized in that:
the system includes a control station comprising:
a functionality for collecting required QoS information of a terminal from the terminal;
a functionality for periodically determining the priority of the handover for the terminal based on the required QoS; and
a functionality for executing the handover procedure on the terminal based on the priority of the handover; and
the control station is configured to execute:
determining the priority of handover procedure for each terminal based on the required QoS collected from the terminals; and
executing the handover procedure after selecting terminals for targets of the handover based on the priority and the number of possible handover occurrences, or determining the order of handover for the terminals based on the priority, at the timing when a trigger of the handover occurs.

The seventh aspect involves the wireless communication system according to the sixth aspect, characterized in that:
the control station selects a terminal to which a conditional handover command is issued based on the priority of handover procedure for each terminal and the number of possible handover occurrences; and
the control station issues the conditional handover command to the selected terminal.

The eighth aspect involves the wireless communication system according to the fifth to seventh aspects, characterized in that the required QoS is derived from any of NSSAI information, 5QI information, and access category information.

The ninth aspect involves the wireless communication system according to the fifth to eighth aspects, characterized in that the required QoS is derived from any of access identity information and terminal type information.

The tenth aspect involves the wireless communication system according to the fifth to ninth aspects, characterized in that a trigger of the handover procedure is recognized when a plurality of terminals move in the same direction within a service area of a communication station and enter another service area of a new communication station and the plurality of terminals simultaneously connect to the new communication station.

The eleventh aspect involves the wireless communication system according to the fifth to ninth aspects, characterized in that a trigger of the handover procedure is recognized when a communication station that a plurality of terminals are connected to moves, then the plurality of terminals enter another service area of a new communication station, and the plurality of terminals simultaneously connect to the new communication station.

The twelfth aspect involves the wireless communication system according to the tenth or eleventh aspect, characterized in that a number of handovers that will occur within a certain period of time in the future is predicted by combining information such as the terminal's location information, location information of the communication station connected to the terminal, movement information of the terminal, movement information of the communication station, and service area information of each communication station,

The thirteenth aspect involves the wireless communication system according to the tenth or eleventh aspect, characterized in that a number of handovers that will occur within a certain period of time in the future is predicted based on the information of handovers that occurred in the past.

The fourteenth aspect involves the wireless communication system according to the fifth to ninth aspects, characterized in that a disruption in the communication route between the communication station connected by a plurality of terminals and the data network is anticipated, and a trigger of the handover procedure is recognized when a plurality of terminals simultaneously connect to a new communication station before the communication route is disrupted.

### REFERENCE SIGNS LIST

10 UE (Terminal)
12 Ground Base Station
14 Mobile Core Network
16 Handover Control Device
18 Data Network
20 Unmanned Aerial Vehicle
22 Train

1. A wireless communication system including a plurality of wireless communication stations connected to a data network, in which wireless terminals located within a service area provided by the wireless communication stations are connected to the wireless communication stations to send and receive packets with the data network, wherein
said wireless communication system is configured to perform:
a handover for switching a connection destination of the wireless terminal from the currently connected wireless communication station to a target wireless communication station as the relative position between the wireless terminal and the wireless communication stations changes;
a priority determination for deciding a priority of the handover for each wireless terminal; and
a priority reflection for proceeding with the handover of a plurality of wireless terminals for which a trigger of the handover has been occurred, according to said priority.

2. The wireless communication system according to claim 1, wherein
said priority determination includes:
collecting required QoS information of a wireless terminal from said wireless terminal; and
determining the priority of the wireless terminal based on the required QoS.

3. The wireless communication system according to claim 2, wherein
said required QoS information is service type information which represents the service provided by the wireless terminal, and the service type information includes at least one of the content of the service, the transmission rate required for the service, and the acceptable delay time for providing the service.

4. The wireless communication system according to claim 1, wherein
said priority reflection includes;
determining order of handover for the plurality of wireless terminals for which the trigger of the handover has been occurred, based on their respective priorities; and
sequentially executing the handover of the plurality of wireless terminals, following the determined order.

5. The wireless communication system according to claim 1, wherein
said priority reflection includes:
obtaining the maximum number of terminals β that can complete the handover within a certain period, which corresponds to the allowable delay time for the handover for the wireless terminals;
selecting one or more wireless terminals as a target for the handover from among the plurality of wireless terminals for which the trigger of the handover has been occurred, so that it falls within the limit of the maximum number of terminals β; and
sequentially proceeding with the handover of the wireless terminals selected as said target.

6. A handover control device for controlling a handover for switching a connection destination of a wireless terminal from a currently connected wireless communication station to a target wireless communication station, in response to the relative positional change of a plurality of wireless communication stations connected to a data network and the wireless terminal connected to said wireless communication stations to send and receive packets with the data network,
said handover control device is configured to perform:
receiving information relating to required QoS of service provided by the wireless terminal from said wireless terminal;
determining priority of the handover for each wireless terminal based on the information related to the required QoS; and
notifying said priority for each wireless terminal to the wireless communications stations in order to cause them to proceed with the handover for the plurality of wireless terminals for which a trigger of the handover has been occurred, according to said priority.

7. A wireless communication method for transmitting and receiving packets, via a plurality of wireless communication stations connected to a data network, between a wireless terminal located within a service area provided by the wireless communication station and the data network, including:
switching a connection destination of the wireless terminal from the currently connected wireless communication station to a target wireless communication station as the relative position between the wireless terminal and the wireless communication stations changes;
deciding a priority of the handover for each wireless terminal; and
proceeding with the handover of a plurality of wireless terminals for which a trigger of the handover has been occurred, according to said priority.

8. A non-transitory computer readable storage medium storing a handover control program for controlling a handover for switching a connection destination of a wireless terminal from a currently connected wireless communication station to a target wireless communication station, in response to the relative positional change of a plurality of wireless communication stations connected to a data network and the wireless terminal connected to said wireless communication stations to send and receive packets with the data network, including a computer readable program for causing a handover control device provided with computer resources to execute
the wireless communication method according to claim 7.
